(19) United States
(12) Patent Application Publication
(10) Pub. No.: US 2005/0231425 A1
(43) Pub. Date: Oct. 20, 2005

(54) Wireless wide area networked precision geolocation

(75) Inventors: Norman Coleman, Picatinny Arsenal, NJ (US); Ken Lam, Picatinny Arsenal, NJ (US); George Papanagopoulos, Picatinny Arsenal, NJ (US); Ching-Fang Lin, Simi Valley, CA (US)

Correspondence Address: Raymond Y. Chan, 108 N. Ynez Ave., #128, Monterey Park, CA, 91754, US

(73) Assignee: American GNC Corporation

(21) Appl. No.: 11/142,927

(22) Filed: Jun. 1, 2005

Related U.S. Application Data
(63) Continuation-in-part of application No. 09/952,632, filed on Sep. 10, 2001.

(51) Int. Cl. A63F 13/00

(52) U.S. Cl. 342/385

(57) ABSTRACT

A networked position multiple tracking system includes a plurality of individual units which are networked multi-tracking devices networked and their location information is shared via a data link. The individual units are organized as groups and groups are further networked to facilitate the data transfer in a large area or different geographical areas. The typical applications of the present invention include tracking of family members; tracking of cab vehicles of a taxi company; tracking of law enforcement officials pursuing criminals or suspects. In a military environment, the soldiers in a regiment can track each other during military missions by using the present invention. The pilots of aircraft in a formation can use the multi-tracking system to maintain formation flight and evade potential collision.

### CROSS REFERENCE OF RELATED APPLICATION

This is a Continuation-In-Part application of a non-provisional application having an application Ser. No. 09/952,632 and filing date of Sep. 10, 2001.

### BACKGROUND OF THE PRESENT INVENTION

1. Field of the Invention

The present invention relates to remote tracking processing, and more particularly to a networked position multiple tracking process, wherein all multi-tracking devices are networked and their location information is shared via a data link. Moreover, individual units are organized as groups and groups are further networked to facilitate the data transfer in a large area or different geographical areas.

2. Description of Related Arts

There is a demand for determining another person's or vehicle's location. There is a further demand for determining other persons' or vehicles' locations relative to a host. The current technology utilizes a monitoring center equipped with computers and communication links. The persons tracked send their location data via a communication resource to a monitoring center. The monitoring center is capable to display their current location on a display unit in real time.

The present invention provides an innovative way to implement the networked tracking of entities without a monitoring center, where an entity can be a person or a vehicle. In the present networked position multiple tracking system, all individuals each of which is given a unique identification (ID) are equal and combined in a group. Each individual can freely leave this group. The group can also receive newcomers as members after the automatic registration process.

### SUMMARY OF THE PRESENT INVENTION

A main objective of the present invention is to provide a networked position multiple tracking process, which is a method to organize individual members or units in a hierarchical architecture. All individual units are organized in a plurality of unit groups, and the unit groups are further organized into larger groups, and so on. Accordingly, the networked position multiple tracking process of the present invention substantially saves communication resource for a communication network and provides efficient data exchanges among big amount of individuals.

Another objective of the present invention is to provide a networked position multiple tracking process, which is a method to acquire the current location of objects in a networked group. The objects are defined as persons or vehicles. These objects' locations are displayed on a host-display, where the host is located at a center of the display so that the host knows the profile of the relative locations of its group members. The present invention allows any person or vehicle with a display unit to display their positions and the positions of any other persons or vehicles in a networked group.

It is a further objective of the present invention to provide a networked position multiple tracking process to acquire the current locations of individuals in a networked group. These individuals' locations are displayed with a map as background on the acquirer's display unit. The present invention allows any person or vehicle with a display unit to display their positions and the relative positions of any other persons or vehicles in a networked group.

It is a further objective of the present invention to provide a networked position multiple tracking process, in which a communication mechanism is designed to facilitate the data transmission among individuals. The data exchange package is also defined.

It is a further objective of the present invention to provide a networked position multiple tracking process, in which an intra-group communication mechanism is designed to facilitate the data transmission among individual groups. The intra-group data exchange package is also defined.

It is a further objective of the present invention to provide a networked position multiple tracking process, in which a self-contained miniature IMU (inertial measurement unit) is used along with a GPS (global positioning system) receiver to deliver uninterrupted positioning data for each individual.

It is a further objective of the present invention to provide an integrated communication and wireless wide area networked precision geolocation system for generic multi-agent high-performance real-time decision aids system.

In order to accomplish the above objectives, the present invention provides a system and process for networked position multiple tracking among independent individuals without a monitoring center, where an individual is a person, a vehicle, or any other property. With such networked multiple tracking system, the individuals are networked in a group, and each individual can search and track other individuals of interest.

The present networked position multiple tracking system is also capable of intra-group tracking, where each group has a group controller who is responsible for data exchange among individual groups.

The individuals' locations are overlaid on a digital map on the host's display unit. The host is at the center of the display, thus the relative locations of other individuals are displayed on the host's display unit. The networked individual can send messages to each other as well.

The typical applications of the present invention include tracking of family members; tracking of cab vehicles of a taxi company and tracking of law enforcement officials pursuing criminals or suspects. In a military environment, the soldiers in a regiment can track each other during military missions by utilizing the present invention. The pilots of aircraft in a formation can use the networked position multiple tracking system to maintain formation flight and evade potential collision.

### BRIEF DESCRIPTION OF THE DRAWINGS

FIG. 1 is a block diagram illustrating a portable multiple tracking unit which comprises a position producer, an intelligent display, a system processor, and a wireless communication device.

FIG. 1a illustrates the interruption free self-contained coremicro Palm Navigator navigation when GPS signals are obscured.

FIG. 2 illustrates the communication architecture for networked position multiple tracking process, where all the individual portable multiple tracking units are equal.

FIG. 3 illustrates the communication architecture for the inter-group data exchanges, where each group has a group controller.

FIG. 4 illustrates the communication architecture with data link relay for the inter-group data exchanging, where each group has a group controller.

FIG. 5 illustrates a hierarchical structure of the individual units and individual groups, where individual units are organized as small groups and small groups are organized as bigger groups, and so on.

FIG. 6 is a block diagram illustrating a communication mechanism in a group.

FIG. 7 is a block diagram illustrating the processing of a networked position multiple tracking unit.

FIG. 8 is a block diagram illustrating the operation flow of the portable multi-tracking system.

FIG. 9 is a block diagram illustrating the communication mechanism among groups.

FIG. 10 is one of the system implementation of the networked position multiple tracking process that presents wireless wide area networked precision geolocation.

### DETAILED DESCRIPTION OF THE PREFERRED EMBODIMENT

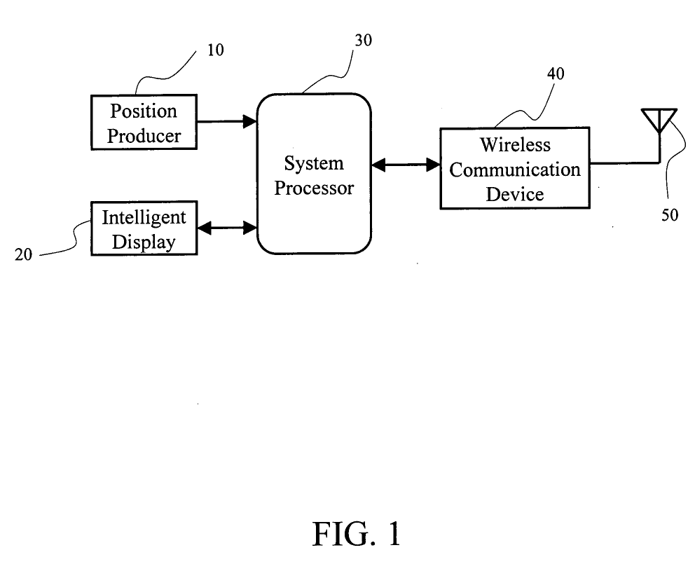

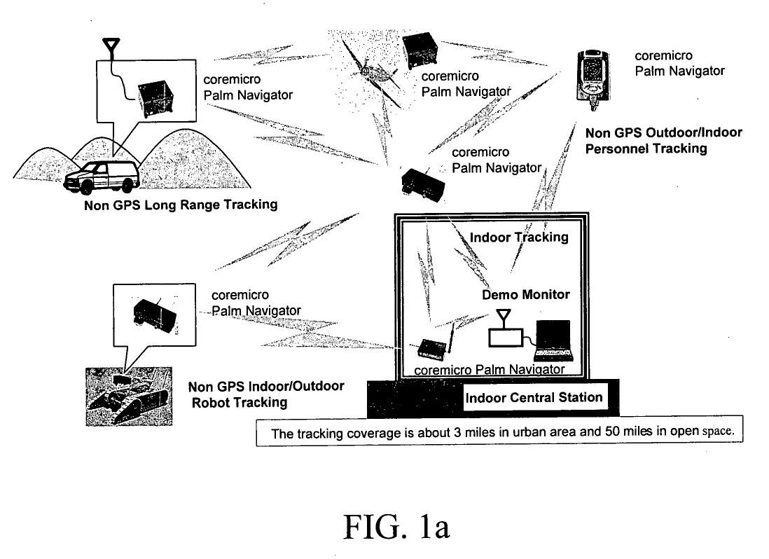

Referring to FIGS. 1 to 10, a system of networked position multiple tracking is illustrated, wherein the networked position multiple tracking system is processed via a data link, where the data link is responsible for location and command data exchanges between individuals among a networked group. According to the networked position multiple tracking system of the present invention, the individuals are networked in a group that each individual can search and track other individuals.

The networked position multiple tracking system comprises a plurality of individual units each of which is carried by an individual carrier, which can be a person, a vehicle, or any other property. The individual units are organized as intra-groups and a predetermined number of unit groups are further networked into link-groups to facilitate the data transfer in a large area or different geographical areas.

The networked position multiple tracking system further comprises a communication mechanism in each unit-group of individual units which is designed to facilitate the data transmission among the individual units, wherein a data exchange package is also defined.

The networked position multiple tracking system further comprises an intra-group communication mechanism in each intra-group of unit-groups, which is designed to facilitate the data transmission among the unit-groups, wherein an intra-group data exchange package is also defined.

The networked position multiple tracking system further comprises a self-contained miniature IMU (inertial measurement unit) which is used along with a GPS (global positioning system) receiver to deliver uninterrupted positioning data for each individual unit.

Equipped with a powerful small size IMU (Inertial Measurement Unit) device, such as the coremicro® IMU invented by the American GNC Corporation, the network position multiple tracking system of the present invention is self-contained and capable of tracking personnel inside a building, where the IMU device provides continuous carrier's position information. In the open area a GPS (Global Positioning System) unit is activated to provide precision absolute location data which can be blended with the self-contained IMU data to improve the accuracy and robustness of the positioning services. Thus, the present invention provides excellent position tracking outside a building.

The IMU/GPS integrated device, in general, is costly and big in size. Weight, and large size lead to an infeasible deployment in a car or for being carried by a single individual. With the emergence of the MEMS (MicroElectronicMechanical System) technology, a miniature IMU based on MEMS technology becomes an embraceable reality.

American GNC Corporation, Simi Valley, CA, invented MEMS angular rate sensors and MEMS IMUs (Inertial Measurement Units), referring to US patents, “MicroElectroMechanical System for Measuring Angular Rate”, U.S. Pat. No. 6,508,122; “Processing Method for Motion Measurement”, U.S. Pat. No. 6,473,713; “Angular Rate Producer with MicroElectroMechanical System Technology”, U.S. Pat. No. 6,311,555; “Micro Inertial Measurement Unit”, U.S. Pat. No. 6,456,939. American GNC Corporation invented the coremicro® IMU, which is currently “The world's smallest” IMU, based on the combination of solid state MicroElectroMechanical Systems (MEMS) inertial sensors and Application Specific Integrated Circuits (ASIC) implementation. The coremicro® IMU is a fully self-contained motion-sensing unit. It provides angle increments, velocity increments, a time base (sync) in three axes and is capable of withstanding high vibration and acceleration. The coremicro® IMU is opening versatile commercial applications, in which conventional IMUs can not be applied, including land navigation, automobile navigation, personal hand held navigators, robotics, marine vehicles and unmanned air vehicles, various communication, instrumentation, guidance, navigation, and control applications.

The coremicro® IMU manufactured by the American GNC Corporation can be embodied into the networked position multiple tracking system for delivering robust location data. As shown in FIG. 1a, American GNC Corporation's (AGNC) coremicro® Palm Navigator system provides precise interruption-free position for multiple platforms communications, tracking and decision aids system for personnel, robots, manned/unmanned ground vehicles (UGV), unmanned aerial vehicles (UAV) and other combat platforms, in complicated environments and terrain where the GPS signals are obscured. It is not a closed system. It is modularized and open to other systems. By providing position data to the central station the coremicro Palm Navigator shows where on the floorplan the Robots/UGG/UAV/personnel are. The application of the coremicro Palm Navigator achieves the Wireless Wide Area Networked Precision Geolocation System for the generic multi-agent high-performance real-time Decision Aids System. The coremicro Palm Navigator is an advanced position/location tracking and communication device based on the coremicro AHRS/INS/GPS Integration Unit. This coremicro Palm Navigator product which provides position and motion information uses the coremicro IMU (Inertial Measurement Unit) and other sensors for interruption-free, highly accurate real time tracking regardless of GPS reception. In applications where GPS loss is intolerable, this coremicro Palm Navigator can be used to reliably track individual users. Advanced digital signal processing, multi-sensor data fusion, filtering, system integration, intelligent control and monitor technologies are employed to achieve high system performance. The coremicro Palm Navigator can be utilized for personal navigation as well as miscellaneous navigation and control applications. The coremicro Palm Navigator is ideal for navigation in metropolitan areas, where GPS is intermittent or altogether unavailable. For indoor tracking it does not require a priori knowledge of the facility, does not need to be part of a building's infrastructure and can be set up quickly. These features make the system particularly useful for urban settings, tracking firefighters, emergency responders, etc. The central/master station can be connected to a laptop or desktop PC to display a graphical view of the relative locations and status of mobile and reference nodes. Repeater reference coremicro Palm Navigators are placed as needed to dynamically expand the coverage area. These coremicro Palm Navigators assist in relaying information between the mobile and master station nodes. Mobile units are equipped with devices, such as, Personal Digital Assistants (PDA) type to show a map of relative mobile, master station and reference node positions.

The networked position multiple tracking system processes the following steps according to the present invention:
(a) Provide a unit data link among a plurality of individual units to form a unit-group. The unit data link creation follows the defined intra-group communication mechanism.
(b) Provide an intra data link among a plurality of unit-groups to form an intra-group. The intra data link creation among unit-groups follows the defined inter-group communication mechanism.
(c) Receive position data from a positioning unit incorporated with each of the individual units, wherein the positioning unit can be a GPS receiver, an IMU positioning device, or an integrated GPS/IMU device, such as AGNC coremicro Palm Navigator. The position data is a three dimensional vector of (x, y, z) coordinates in the Earth-Centered-Earth-Fixed (ECEF) coordinate system, or of (latitude, longitude, altitude) coordinates in the Geodetic coordinate system.
(d) Receive data from a wireless communication module employed in each of the individual units, where the wireless communication module creates and maintains a communication resource with other individual units. The data received from the wireless communication module includes client location data, identifications (IDs), inquiring commands, and other messages of the other individual units.
(e) Process the received data, retrieve map data from a map database stored in a storage device of each of the individual units, display a host location data on the map, decode the data from other individual units, and display the client location data on the map.
(f) Send the host and client location data and identifications via the wireless communication module to a network to the other individual units for the other individuals of the individual units to access these data.

As shown in FIG. 1, each of the individual units is a networked position multiple tracking device which comprises a position producer 10 such as AGNC coremicro Palm Navigator, an intelligent display 20, a system processor 30, a wireless communication device 40, and an antenna 50. The position producer 10 is responsible for the delivery of location data. It can be an IMU (inertial measurement unit), a GPS (global positioning system) receiver, or an IMU/GPS integrated device.

The intelligent display 20 is used to show the host location and other relative client locations of to the individual units. The system processor 30 is responsible for sending and receiving data, retrieving map data, responding to commands, and numerical calculations. The wireless communication device 40 is used to receive and send location data and other messages.

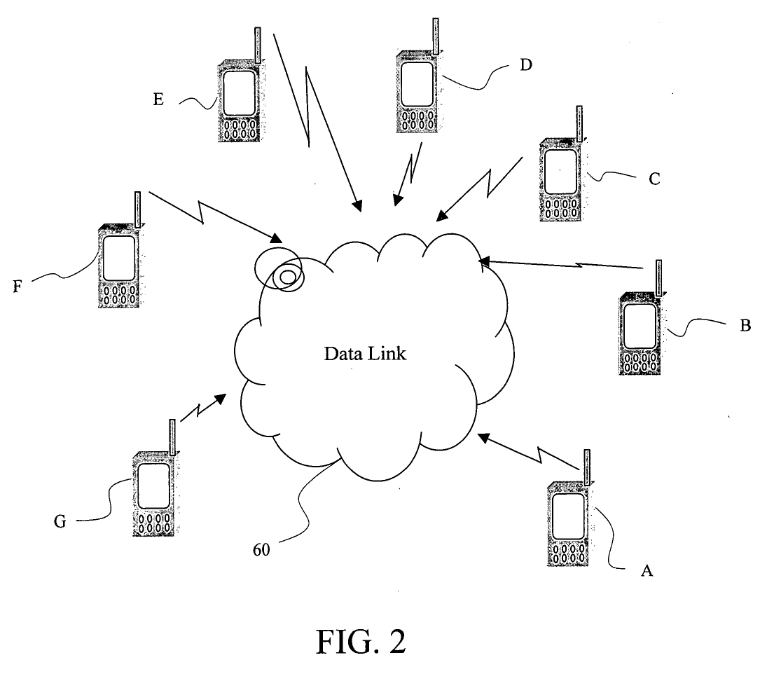

As shown in FIG. 2, the communication architecture of the networked multiple tracking process is designed to meet the following requirements:
(1) Assignment of communication resource 60, i.e. the unit data link, can be made to individual units (A, B, 1C, D, E, F, and G) that occasionally approach the host.
(2) Free data exchange is allowed among the individual units within a unit-group or a specific area.
(3) Release of the assigned communication resource 60 can be made when an individual unit leaves the specific area.
   Logically, the communication resource works with the following steps:
(1) ID Presetting: each individual unit in a unit-group should be assigned a unique ID.
(2) Partner Querying: when a partner individual unit is assigned in a unit-group, it keeps signaling for other partner individual units.
(3) ID Recognition User Registration: when a partner individual unit's ID is received, the ID will be logged to its registration table.
(4) Group Negotiation for Communication Resource Assignment: each partner individual unit inside the unit-group negotiates for the communication resource assignment for the new approaching individual unit.
(5) Data Exchange I: each partner individual unit in the unit-group transmits its position and other dynamic state together with its unique ID.
(6) Data Exchange II: each partner individual unit in the unit-group receives the information from other partner individual units to derive their dynamic states and to determine all partner individual units existing in the unit-group.
(7) Resources Recycling: when no partner individual unit in the unit-group receives any information from a specific partner individual unit, the specific partner individual unit will be deleted from the unit-group, and the communication resource 60 assigned to this specific partner individual unit will become available for other potential partner individual units.

The Data Exchange Package is defined to include:
(i) Unit ID Number of each Individual unit
(ii) All Registered Unit IDs in a Registration Table
(iii) State information, Position, Attitude, Time Stamp, etc.

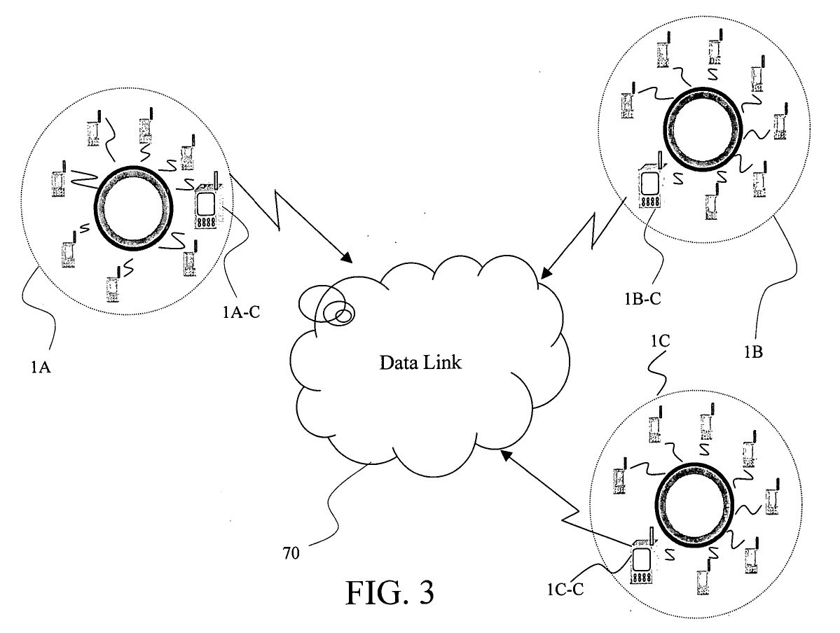

As shown in FIG. 3, the intra-group communication mechanism is defined to include:
(i) Unit-Group Registration
(ii) Gather the Information from All Available Unit-Groups
(iii) Request for Specific Unit's State from a Specific Unit-Group.
(iv) Offers the state of Unit to other unit-groups in respond to the request

As shown in FIG. 3, another communication resource, i.e. the intra data link 70, is responsible for delivering position data and other messages among unit-groups (1A and 1B). Each unit-group has a Group Controller (1A-C or 1B-C). This Group Controller is responsible for:
Keep Transmitting the Group Registration Code, which includes Group ID
Upon it been registered, it will transmit Group Information Package. The Package includes: Group ID, Group member's ID, Group communication status Info.

The intra-Group Data Exchange Package is defined to include:
(i) Intra-Group ID
(ii) Intra-Group Controller's ID
(iii) Intra-Group controller's state information (Position, Attitude, Time Stamp)
(iv) Intra-Group members' ID
(v) Intra-Group members' state information

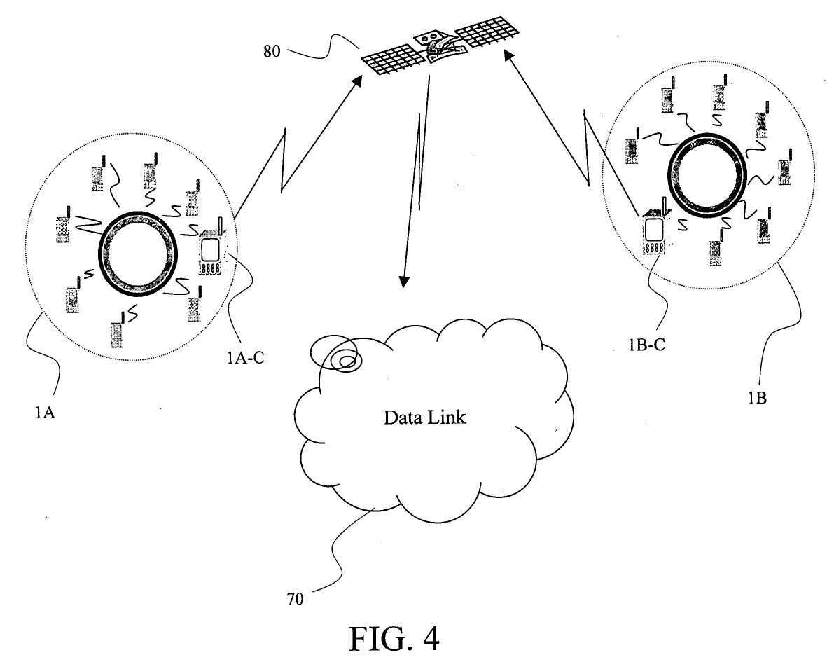

FIG. 4 illustrates a network architecture including a communication satellite 80, which is an alternative intra data link. In this architecture the communication satellite relays data transmission among individual unit-groups or intra-groups to cover a large area.

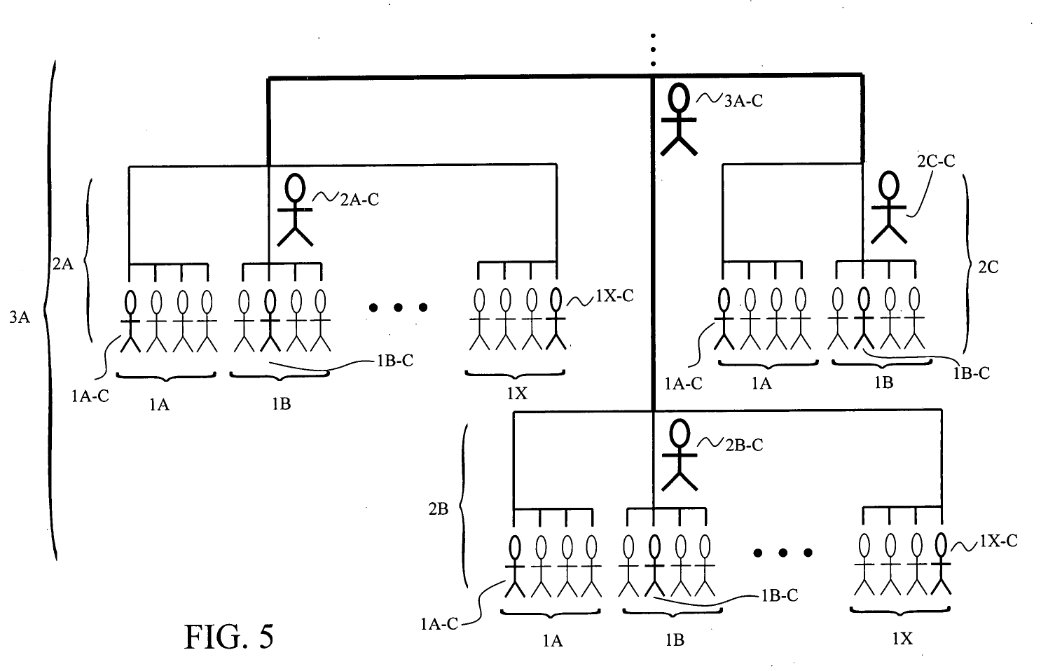

FIG. 5 illustrates a three level hierarchical structure of the organization of individual units, unit-groups and intra-groups. All individual units are organized into first level unit-groups. Each individual unit is denoted as A, B, or C, and so on. Each first level unit-group is denoted as 1A, 1B, or 1C, and so on. Each small unit-group has a first level unit group controller denoted as 1A-C for first level group 1A, 1B-C for first level group 1B, and so on. All first level unit-groups are organized as a second level intra-group denoted as 2A, 2B, or 2C, and so on. Each second level intra-group has a second level intra group controller denoted as 2A-C for second level intra-group 2A, 2A-C for second level intra-group 2B, and so on. All second level intra-groups are organized as a third level intra-group denoted as 3A, 3B, or 3C, and so on. Each third level intra-group has a third level intra group controller denoted as 3A-C for third level intra-group 3A, 3B-C for third level intra-group 3B, and so on.

As shown in FIG. 5, the first level unit group controller can be one of individual units gathered in this first level unit-group. Second level intra group controller, 2A-C, 2B-C, or 2C-C in FIG. 5 can be one of the first level unit group controllers gathered in this second level intra group. It is also acceptable to have a specific or independent individual unit acting as the second level intra group controller. Third level intra group controller, 3A-C in FIG. 5 can be one of the second level intra group controllers gathered in this third level intra-group. It is also acceptable to have a specific or independent individual unit acting as the third level intra group controller.

Each individual unit in each of the first level unit-groups is assigned with a unique individual identification (IID) to distinguish from other individual units in the same first level unit-group. Each first level unit-group in a second level intra-group is assigned with a unique first level group identification (GID) to distinguish from other first level unit-groups in the same second level intra-group. Each second level intra-group in a third level intra-group is assigned a unique second level group identification (GID) to distinguish from other second level intra-groups in the same third level intra-group. This same way of identification assignment continues for even larger groups. By this way the hierarchical architecture can trace down to every individual unit with a unique combination of GID and IID. For example, the third level intra-group 3A can be identified in FIG. 5. Then second level intra-group 2B can be recognized and first level unit-group 1A would be distinguished in the second level intra-group 2B. Finally individual units in the first level unit-group 1A can be identified. The process flow follows: 3A→2B→1A→X, where the number before the letter denotes the level of group, the letter distinguishes each member in this group, and X is an individual units in the first level unit-group.

The position producer 10 outputs the host location data, i.e. the location data of the unit group controller or intra group controller, to the system processor 30. The system processor combines the host location data with the host's ID, i.e. the IID or GID, and sends them to the wireless communication device 40. The wireless communication device 40 is a combination of hardware and software and is responsible to send these data onto the network so that other individual units can access these data. The data stream sent from the unit group controller or intra group controller has an order as follows (in words):
(1) Time Tag in milliseconds: 1 word.
(2) ID: 1 word, when necessary it can be extended into 2 words to encompass more mobile users.
(3) Three dimensional location in the Geodetic coordinate system, including Latitude in radians, Longitude in radians, height above sea level in meters. Each location component occupies 1 word.
(4) Three dimensional location in an earth-centered inertial coordinate system (ECIZ). Each location component occupies 1 word.
(5) Three dimensional velocity in an earth-centered inertial coordinate system (ECIZ). Each velocity component occupies 1 word.

The above motion parameters are sufficient for characterizing a ground vehicle to realize multi-tracking. When used for aircraft tracking, the message will be enhanced by adding the following information:
(6) Three dimensional acceleration in an earth-centered inertial coordinate system (ECIZ). Each acceleration component occupies 1 word.
(7) Rotation matrix from the earth-centered inertial coordinate system to the body coordinate system (BC).
(8) Three dimensional angular velocity in radians/second when the observer is in an earth-centered inertial coordinate system and the resolution is in the body coordinate system.
(9) Three dimensional angular acceleration in radians/second² when the observer is in the earth-centered inertial coordinate system and the resolution is in the body coordinate system.

In order to simplify the following description regarding both the communication resources, i.e. the unit data link 60 and intra data link 70, the following term “group” represents both the “unit-group” and “intra-group” and the following term “member” represents the “individual unit” of a unit-group, the “unit group controller” of a unit-group within an intra-group, and the “intra group controller” of an intra-group within a higher level intra-group.

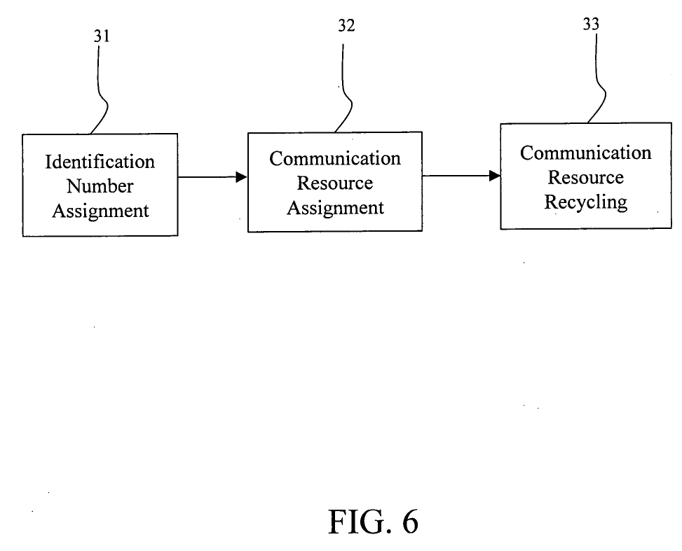

FIG. 6 illustrates the processing of creating and maintaining a communication network among individual units, which comprises a plurality of modules of identification number assignment 31, communication resource assignment 32, and communication resource recycling 33.

The identification number assignment module 31 assigns the unique identification number (IID or GID) to each member involved in the networked position multiple tracking processing. Each member can be recognized by the assigned IID or GID.

The communication resource assignment module 32 assigns communication resource to each member in a group, where communication resource is an opportunity for a networked position multiple tracking device to send data onto the network. For a time-division-multi-address (TDMA) configuration, the communication resource is a piece of time slot assigned to a specific individual during which this individual can send data out. For a frequency-division-multi-address (FDMA) configuration, the communication resource is a radio frequency which the member uses to transmit data. For a code-division-multi-address (CDMA) configuration, the communication resource is a random pseudo number sequence used to identify member in a networked group.

The communication resource recycling module 33 releases communication resource assigned to a specific individual unit when this member leaves the networked group. This step is very important in that the communication resource can be reused by other potential member after one member leaves the group.

The communication resource management is a very important issue in the present invention. The above three steps represent a very competitive group communication mechanism with communication resource assignment and releasing operations. In a TDMA communication network, each member is assigned a piece of time for data transmission. For instance, the required position update rate for each member is once per second (1 Hertz) and required time period for a member to transmit position data is 100 milliseconds. The number of maximum allowed members in a group with this TDMA configuration is 10. When there are less than 10 members in this group, the position transmission rate would be higher. If there are more than 10 members in this group, the position transmission rate would be lower than 1 Hz.

To illustrate the advantage of the efficient communication resource management of the present invention, a more detailed example is provided. In a TDMA configuration communication network, there are 5 members. The required position update rate for each member is still once per second (1 Hertz). The time period for a member to transmit position data is 100 milliseconds. The total time period for all the five members to transmit their position data is 0.5 seconds and meets the position update rate requirement. The communication network capacity can allow another five members to join in. The communication network can not handle more 10 members and meets the 1 Hz position update rate. If we do not have communication resource releasing operation, the communication network can only allow another five members to join in even when one or more members leave this group. With the communication resource releasing operation of the present invention, the communication network can allow another 5+N members to join in when N (N<=5) members leave this group.

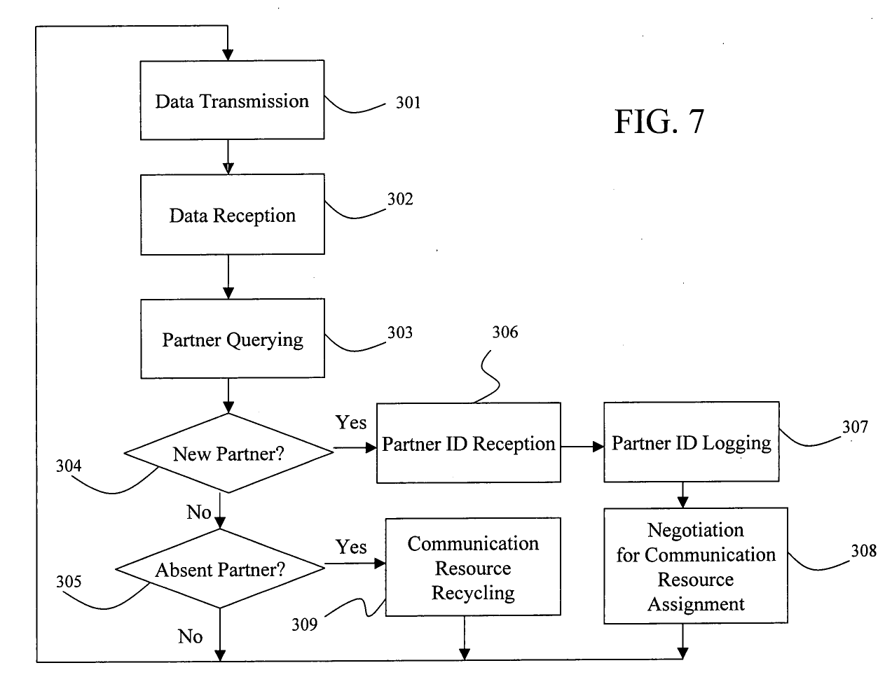

As shown in FIG. 7, the data processing in the networked position multiple tracking system is carried by functional modules of data transmission 301, data reception 302, partner querying 303, new partner checking 304, absent partner checking 305, partner ID reception 306, partner ID logging 307, negotiation for communication resource assignment 308, and communication resource recycling 309. The data processing comprises the steps of:
(a) Transmit position data and other messages along with ID onto the network. This step is to inform other members the existence of the host, i.e. the unit group controller or the intra group controller, in the networked group and its position information.
(b) Receive data from network. This step is to capture other members' information including position data and IDs. Steps (1) and (2) finish the data exchange among members.
(c) Query partners. This step is to search for new partner members and to check absent partner members. The new partner members are defined as new individual units, unit group controllers or intra group controllers coming into this network. On the host there is a partner ID registration Table on which all members among a group are listed. Searching for new partner members can be finished by comparing received IDs (IID or GID) with IDs (IID or GID) on the partner ID registration Table. The absent partner members are defined as individual units, unit group controllers or intra group controllers who left the network. Checking absent partner members can be performed by checking the time period for which an ID (IID or GID) corresponding to a specific member has not been received.

When new partner members are found, the following additional steps are included:
(i) Receiving new partner IDs.
(ii) Logging the new partner IDs onto the partner ID registration Table.
(iii) Negotiating for communication resource assignment.

When absent partner member or members are found, the following additional step is included:
(iv) Releasing communication resources assigned to the absent partner member or members.

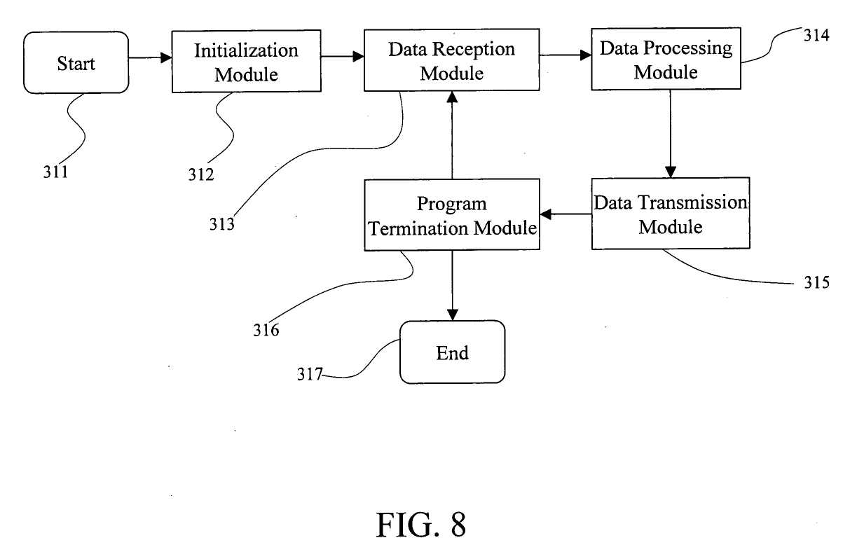

FIG. 8 shows the networked multi-tracking mechanism in accordance with the present invention. It comprises a start module 311, an initialization module 312, a data reception module 313, a data processing module 314, a data transmission module 315, a program termination module 316, and an end module 317.

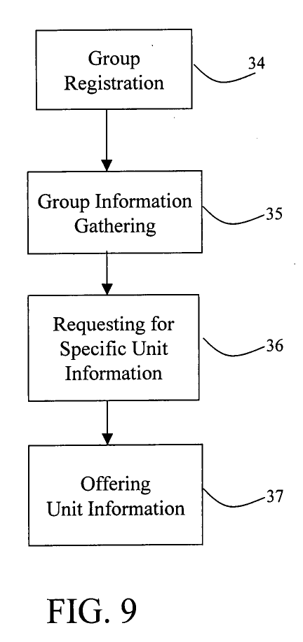

FIG. 9 illustrates the processing of creating and maintaining a communication network among unit-groups and intra-groups, which comprises of functional modules of group registration 34, group information gathering 35, requesting for specific unit information 36, and offering unit information 37. The processing comprises the following steps:
(1) Perform group registration. Each unit-group or intra-group involved in the network is assigned a group registration code and a unique group ID (GID). As mentioned above, each unit-group has a unit group controller and each intra-group has an intra group controller.
(2) Gather information from all involved unit-groups or intra-group by unit group controllers in each unit-group or intra group controllers in each intra-group.
(3) Request information for a specific individual unit from a specific unit-group by a unit group controller, a specific unit group controller by an intra group controller, or a specific intra group controller by another intra group controller in a higher level intra-group.
(4) Keep transmitting group information package, including group ID, group registration code, each member's ID in a group, group controller's information, and group communication status.
(5) Send the position data and other messages associated with a specific individual unit to other unit-group from a unit group controller upon requested from other unit-groups or a specific unit group controller to other unit group controller from an intra group controller upon requested from other intra-groups.

The unit-group and intra-group communication mechanisms can be built on several wireless communication specifications that offer wireless connectivity in various ways. Data rate transfers and range are among the most salient characteristics among wireless products. Several of the wireless solutions are briefly outlined below.

Infrared Data Association (IrDA): This communication system is created through a web of infrared light. It can only be used in open spaces since it is unable to penetrate walls or any other solid surface.

Digital Enhanced Cordless Telecommunications (DECT): Characterized by a “handover” process that uses two radio links during each connection and selects the best of the two for the communication process. If the portable device moves out of range of the base station, the handover process allows for the range to be increased by allowing the portable device to use another nearby range station.

IEEE 802.11: Uses three physical (PHY) layer specifications and one Medium Access Control (MAC) specification. The MAC works in two configurations one is the “Independent Configuration” and the second is the “Infrastructure Configuration”. The Independent Configuration is an ad-hoc network where stations communicate with one another without infrastructure support. In the Infrastructure Configuration stations communicate through access points and their communication scheme creates a wide area coverage. The MAC provides encryption and service scanning. The three PHY include “Frequency Hop Spread Spectrum”, “Direct Sequence Spread Spectrum” and “Baseband IR”. One of its biggest defaults is its very slow frequency hopping rates.

IEEE 802.11b : The PHY layer is extended in this version to provide 5.5 and 11 Mb/s, in addition to the 1 and 2 Mb/s data rates.

HOMERF: Strong in the home wireless networking market and based on the specifications created by the HRFWG. HOMERF deals in the market of communications between mobile devices and PC's.

Shared Wireless Access Protocol (SWAP): Able to carry both voice and data traffic. Voice “re-transmission” takes place first. Data packets are transmitted on several links in the IIDdle of the transmission and finally a voice transmission is received at the end. SWAP is designed to be low cost by using more relaxed radio specifications while maintaining the same frequency-hopping scheme of Bluetooth technology. SWAP is operable as either an add-hoc network or as a managed network.

High Performance Radio Local Area Network (HIPERLAN): HIPERLAN has two specifications, H1 and H2. It is said to work well in building propagation, and high-rate medium range multimedia. Both specifications are expensive to implement.

Bluetooth: Bluetooth wireless technology has several key factors that make it a feasible alternative for the Advanced Personal Communicator Prototype. Some of the more pronounced traits that favor this technology are outlined below:
(a) Due to the fact that Bluetooth technology operates within the world wide unlicensed 2.4 GHz spectrum, the Advanced Personal Communicator can be operated anywhere.
(b) Bluetooth communications can be encrypted.
(c) One of Bluetooth's main objectives is to produce a very low cost wireless communication alternative.
(d) Bluetooth has a Special Interest Group (SIG) that developers can join. Members are granted a free license to use the technology.
(e) Bluetooth technology is very low power since it was designed to run from batteries.
(f) Although Bluetooth technology purpose is to operate at a modest range of 10 meters, a power amplifier with a range of about 100 meters can be incorporated.

Applications providing Bluetooth services must do so through the Bluetooth Protocol Stack. The Bluetooth protocol stack is made up of the following layers: Radio, Baseband, Link Controller, Link Manager, Host Controller Interface (HCI), L2CAP, RFCOMM/SDP and Application layer.

The Radio interface is made up of an on air channel medium and a digital baseband, which handles data sent by the LC and ensures a robust transmission over the channel. The Radio Interface also retrieves data from the channel for processing in higher protocol layers. Radio and baseband represent the Open Systems Interconnect (OSI) Physical layer.

The Baseband layer is where the channel coding and decoding process takes place as well as the timing control.

Link Controller (LC) performs some of the equivalent Data Link layers tasks of transmission and error suppression. The LC executes linking operations over multiple data bursts when instructed to do so by Link Manager (LM) commands.

The LM and the higher end LC are responsible for the execution of the tasks that the network layer performs. The link manager is responsible for the setup and maintenance of multiple links.

The Transport layer tasks are performed by the Host Controller Interface (HCI) which is responsible for faithful data transfer.

Logical Link Control and Adaptation Protocol (L2CAP) and the lower end of RFCOMM/SDP are responsible for the management of data flow.

RFCOMM is the equivalent of the RS-232 layer within the Bluetooth Protocol. It is predominantly responsible for data transfers.

Service Discovery Protocol (SDP) allows users to browse for services or devices such as printers. The Applications layer acts as the communication manager between two application sessions.

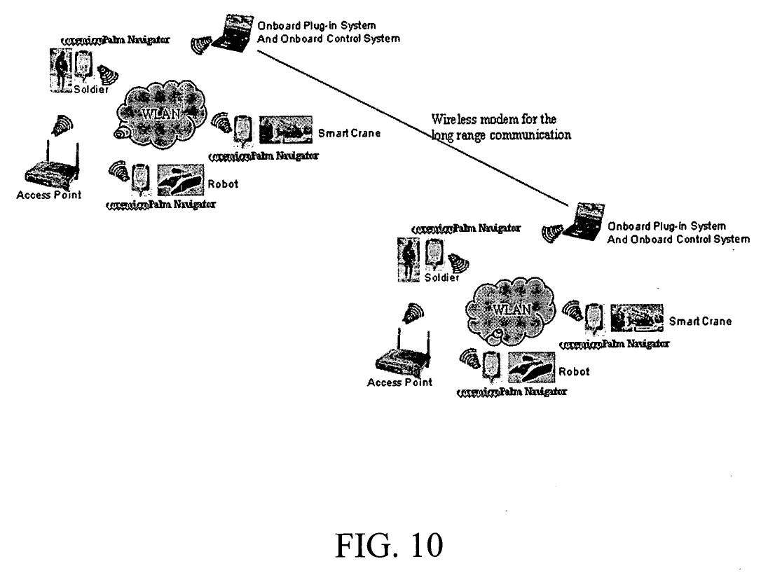

FIG. 10 is one of the system implementation of the networked position multiple tracking process that presents wireless wide area networked precision geolocation. The specific objective of this invention is to demonstrate the feasibility of an innovative Integrated Communication and Wireless Wide Area Networked Precision Geolocation system for generic multi-agent high-performance real-time Decision Aids System, such as, Homeland Defense and Combat Decision Aids System (CDAS) for Future Combat System (FCS) in which an innovative real-time multi-agent information fusion and decision-aid system is created to deploy in a battlespace environment. In this system multi-agent communications, tracking, information fusion and decision aids components have been integrated for different applications. Personnel/Platform tracking and navigation is an essential part for homeland defense and FCS applications where one urgently needs to have novel position/location tracking, communications system and decision making devices that would permit multi-tracking, reporting and recording operations in an open range, as well as in mountainous canyons, under metropolitan buildings canopies, heavy forests, caves, and indoor environments. Currently, tracking personnel in a wide maneuvers range is normally accomplished by using Global Positioning System (GPS) equipment. Though the GPS receiver provides an easy positioning and navigation solution for a wide range of applications, the signals from GPS satellites can be jammed or blocked in complicated terrain, such as, metropolitan buildings canopies, caves, and indoor environments.

The Wireless Wide Area Networked Precision Geolocation System incorporates the coremicro Palm Navigator that performs network communication, improves geolocation accuracy when loss of the GPS signal occurs, and increases the tracking area coverage at the same time. The system has been integrated with the US Army's Research Development and Engineering Center's (ARDEC) CDAS FCS, Objective Force Warrior, Land Warrior and Homeland Defense applications. For all applications, this system allows personnel to be linked through an intelligent software network interface to multiple autonomous robotic vehicles and airplanes/UAVs that provide precision geolocation and other information to each other. This is one of the basic concepts of the U.S. Army's FCS. FIG. 10 depicts the basic concept of the Wireless Wide Area Networked Precision Geolocation System for Communication and Tracking of the Future Combat System.

An “open systems” architecture is built with specified interfaces, services and respective formats to support plug-and-play software and hardware components. A decision-level fusion-based, such as, object-oriented Bayesian Network, configuration accommodates complex systems and inference. A wireless communication architecture supports multi-agent communication and coordination. Using the American GNC Corporation's (AGNC) developed simulation and test tools the system is tested in the laboratory and then in the CDAS environment. The development leads to a general purpose, reusable. plug-and-play commercial software component product referred to as Reusable Component-Based Multi-agent Information Fusion and Decision Aid System.

Applications address cases where personnel, through a network, can access positioning information. There are two layers to this construct. One is a self contained network and the other a link to an application layer that monitors the network. This provides flexibility to various applications. The radio link can accommodate a Linux network which is the environment for the future warrior. It can display desired waypoints. Once the information is on the network many applications ensue. The interface to CDAS is a very fast link to a central station and then the central station can talk to CDAS. Also, CDAS can talk to the central station and send waypoints. The impact of this design includes:
(1) Significant enhancement of the performance for decision aid systems.
(2) Innovative self-contained personnel tracking system for applications, such as: trajectory guided three-dimensional course guidance system, urban integrated soldier identification system using cellular technology, wireless handheld location based decision-making system, and networked coremicro Palm Navigator system for urban warfare.
(3) Significantly enhances the efficiency of the multi-agent tracking network.
(4) Real time decision aid in highly complex information environments.
(5) Open systems architecture with plug-and-play components.

System components and technical innovations include:
(1) A distributed processing architecture is designed to significantly reduce the communication bandwidth requirement and improve the system robustness.
(2) A high performance Kalman filter is applied to the battlespace environment.
(3) A decision fusion algorithm is able to represent complex systems and inference. The sensor's agent characteristics along with signal features play the key roles in agent recognition by determining agent types (IDs) because the decision fusion algorithm is based on agent types from multiple sensors.
(4) A robust distributed decision aid and accurate engagement component is established to support command and fire control.

Referring to FIGS. 1 to 10, one of the system implementation of networked position multiple tracking which is called “wireless wide area networked precision geolocation” is illustrated, wherein the “wireless wide area networked precision geolocation” is processed via a data link, where the data link is responsible for location and command data exchanges between individuals among a networked group. According to the wireless wide area networked precision geolocation of the present invention, the individuals are networked in a group that each individual can search and track other individuals.

The wireless wide area networked precision geolocation comprises a plurality of individual units each of which is carried by an individual carrier, which can be a person, a vehicle, or any other property. The individual units are organized as intra-groups and a predetermined number of unit groups are further networked into link-groups to facilitate the data transfer in a large area or different geographical areas.

The wireless wide area networked precision geolocation further comprises a communication mechanism in each unit-group of individual units which is designed to facilitate the data transmission among the individual units, wherein a data exchange package is also defined.

The wireless wide area networked precision geolocation further comprises an intra-group communication mechanism in each intra-group of unit-groups, which is designed to facilitate the data transmission among the unit-groups, wherein an intra-group data exchange package is also defined, as shown in FIG. 10.

The wireless wide area networked precision geolocation system processes the following steps according to the present invention:
(a) Provide a unit data link among a plurality of individual units to form a unit-group. The unit data link creation follows the defined intra-group communication mechanism. The wireless LAN is used for the short range and high speed communication. Real time image is transferred through the wireless LAN.
(b) Provide an intra data link among a plurality of unit-groups to form an intra-group. The intra data link creation among unit-groups follows the defined inter-group communication mechanism. The wireless modem is used for the long range and low speed communication. Real time command and request is transferred through the wireless modem.
(c) Receive position data from a positioning unit incorporated with each of the individual units, wherein the positioning unit can be a GPS receiver, an IMU positioning device, or an integrated GPS/IMU device. The position data is a three dimensional vector of (x, y, z) coordinates in the Earth-Centered-Earth-Fixed (ECEF) coordinate system, or of (latitude, longitude, altitude) coordinates in the Geodetic coordinate system. The position unit provides position for both indoor and outdoor tracking.
(d) Receive data from a wireless communication module employed in each of the individual units, where the wireless communication module creates and maintains a communication resource with other individual units. The data received from the wireless communication module includes client location data, identifications (IDs), inquiring commands, and other messages of the other individual units.
(e) Process the received data, retrieve map data from a map database stored in a storage device of each of the individual units, display a host location data on the map, decode the data from other individual units, and display the client location data on the map.
(f) Send the host and client location data and identifications via the wireless communication module to a network to the other individual units for the other individuals of the individual units to access these data.

1. A wireless wide area networked precision geolocation (WWANPG), comprising:
two or more unit-groups, each of which comprises:
two or more individual units each of which is carried by an individual carrier, wherein one of said individual units is assigned as a unit group controller, and
a unit communication network, which networks said individual units to form an intra group, comprising a first communication means for transferring a data exchange package which includes position data and an individual identification (IID) of each of said individual units among said individual units, wherein said unit group controller collects all said position data of said individual units and sends said position data of said individual units under request of each of said individual units; and
an inter communication network, which networks said unit-groups, comprising a second communication means for communicating said intra groups with each other to transfer an intra-group data exchange package which includes position data and a group identification (GID) of each of said unit group controllers among said unit-groups.

2. The wireless wide area networked precision geolocation, as recited in claim 1, wherein said first communication means comprises a WLAN for short-range intra-group communication and said second communication means comprises a wireless modem for ling-range inter-group data transmission.

3. The wireless wide area networked precision geolocation, as recited in claim 1, wherein one of said individual units in said intra-group is assigned as an intra group controller which collects all said position data of said unit group controllers and sends said position data of said unit group controllers under request of each of said unit group controllers.

4. The wireless wide area networked precision geolocation, as recited in claim 2, wherein one of said individual units in said intra-group is assigned as an intra group controller which collects all said position data of said unit group controllers and sends said position data of said unit group controllers under request of each of said unit group controllers.

5. The wireless wide area networked precision geolocation, as recited in claim 3, wherein said intra group controller is assigned from one of said unit group controllers.

6. The wireless wide area networked precision geolocation, as recited in claim 4, wherein said intra group controller is assigned from one of said unit group controllers.

7. The wireless wide area networked precision geolocation, as recited in claim 4, wherein said position data collected from and sent to each of said unit group controllers include said position data of each of said individual units in said respective unit-group.

8. The wireless wide area networked precision geolocation, as recited in claim 6, wherein said position data collected from and sent to each of said unit group controllers include said position data of each of said individual units in said respective unit-group.

9. The wireless wide area networked precision geolocation, as recited in claim 1, wherein each of said individual units further comprises a position producer producing said position data of said individual unit including three dimensional vector of (x, y, z) coordinates in an Earth-Centered-Earth-Fixed (ECEF) coordinate system.

10. The wireless wide area networked precision geolocation, as recited in claim 4, wherein each of said individual units further comprises a position producer producing said position data of said individual unit including three dimensional vector of (x, y, z) coordinates in an Earth-Centered-Earth-Fixed (ECEF) coordinate system.

11. The wireless wide area networked precision geolocation, as recited in claim 8, wherein each of said individual units further comprises a position producer producing said position data of said individual unit including three dimensional vector of (x, y, z) coordinates in an Earth-Centered-Earth-Fixed (ECEF) coordinate system.

12. The wireless wide area networked precision geolocation, as recited in claim 1, wherein each of said individual units further comprises a position producer producing said position data of said individual unit including latitude, longitude, and altitude coordinates in a Geodetic coordinate system.

13. The wireless wide area networked precision geolocation, as recited in claim 4, wherein each of said individual units further comprises a position producer producing said position data of said individual unit including latitude, longitude, and altitude coordinates in a Geodetic coordinate system.

14. The wireless wide area networked precision geolocation, as recited in claim 8, wherein each of said individual units further comprises a position producer producing said position data of said individual unit including latitude, longitude, and altitude coordinates in a Geodetic coordinate system.

15. A process of wireless wide area networked precision geolocation (WWANPG), comprising the steps of:
(a) networking two or more individual units to form an intra group, each of which is a position tracking device carried by an individual carrier, to form a host unit-group via WLAN, wherein each of said individual units is assigned with a unique individual identification (IID);
(b) assigning one of said individual units in said host unit-group as a host unit group controller, wherein a unique group identification (GID) is assigned to said host unit group controller; and
(c) collecting position data of said individual units by said host unit group controller via said WLAN so as to ensure said host unit group controller having said position data of all said individual units of said host unit-group;
(d) obtaining said position data of said other individual units within said host unit-group by one of said individual units from said host unit group controller via said WLAN;
(e) providing one or more client unit-groups to network with said host unit-group via a wireless modem to form an intra-group, wherein
(i) each of said client unit-groups also comprises two or more individual units networked with an independent unit communication network,
(ii) each of said individual units networked in each of said client unit-groups is assigned with a unique individual identification;
(iii) one of said individual units is assigned as a client unit group controller and a unique group identification (GID) is assigned to said client unit group controller;
(iv) said client unit group controller collects position data of said individual units in each of said client unit-groups, so as to ensure said client group controller having said position data of all said individual units of said client unit-groups; and
(v) each of said individual units of each of said client unit-groups is capable of obtaining said position data of said other individual units within said client unit-group from said client unit group controller via said independent unit communication network of said client unit-group;
(f) assigning one of said individual units in said intra-group as an intra group controller of said intra-group, wherein a unique group identification (GID) is assigned to said intra group controller; and
(g) collecting position data of said host and client unit-groups by said intra group controller via said wireless modem so as to ensure said intra group controller having said position data of all said host and client unit-groups; and
(h) obtaining said position data of said other host and client unit-groups within said intra-group by one of said client unit group controllers from said intra group controller via said wireless modem.

16. The process, as recited in claim 15, further comprising the steps of:
(i) providing one or more additional intra-groups to network with said intra-group via a high level intra communication network to form a high level intra-group;
(j) assigning one of said individual units in said intra-groups as a high level intra group controller of said high level intra-group which is responsible for communication with said other intra group controllers of said intra-groups, wherein a unique group identification (GID) is assigned to said high level intra group controller;
(k) collecting position data of said intra-groups by said high level intra group controller via said high level intra communication network so as to ensure said high level intra group controller having said position data of all said intra-groups; and
(l) obtaining said position data of said other intra-groups within said high level intra-group by one of said intra group controllers from said high level intra group controller via said high level intra communication network.

17. The process, as recited in claim 16, wherein said high level intra group controller is assigned from one of said intra group controllers of said intra-groups.

18. The process, as recited in claim 15, wherein said position data of each of said intra-groups include said position data of all said individual units of said host and client unit-groups within said intra-group.

19. The process, as recited in claim 16, wherein said position data of each of said intra-groups include said position data of all said individual units of said host and client unit-groups within said intra-group.

20. The process, as recited in claim 17, wherein said position data of each of said intra-groups include said position data of all said individual units of said host and client unit-groups within said intra-group.
